(19) United States
(12) Patent Application Publication
(10) Pub. No.: US 2007/0214028 A1
(43) Pub. Date: Sep. 13, 2007

(54) System And Method For Automatically Installing Verifying And Configuring Functionalities In The System Components Of A Distributed Network

(75) Inventors: Christian M. Stich, Schriesheim (DE); Marcel Dix, Mannheim (DE); Peter Johann Walther Schemat, Vasteras (SE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 10/574,948

(22) PCT Filed: Apr. 28, 2004
(86) PCT No.: PCT/EP04/04470

§ 371 Date: Jan. 11, 2007

(30) Foreign Application Priority Data
Nov. 28, 2003 (DE) 10356368.7

(51) Int. Cl. G06F 9/46

(52) U.S. Cl. 705/8

(57) ABSTRACT

The invention relates to a system for the automatic installation, verification and configuration of functionality that is stored in installation, verification and/or configuration files for system components that are located in a distributed network. Said system comprises a system design tool for generating, checking and configuring the installation, verification and/or configuration files for the respective system components. According to the invention, the system design tool transmits the installation, verification and/or configuration files to the system components for installation, the installation, verification and/or configuration files required in the respective system components are checked and configured in a predetermined sequence and manner and a complete system is formed once the system components have been configured.

The invention relates to a system and a method for automatically creating, installing and configuring functionalities, stored in files, particularly in installation, verification and/or configuration files, for the system components arranged in a distributed network, particularly in a distributed automation system.

The design of a distributed network comprises a multiplicity of system components which are connected via a network structure, with the system components being operator stations, engineering stations, archiving stations, controllers with processing stations, input and output units and communication interfaces, for example.

The system components of the distributed system store an operating system, application programs and control programs, for example, which are installed and configured as software packages in the system components.

To create, install and configure the installation, verification and/or configuration files stored in software packages for the system components of the distributed system, the software packages required for the network to be able to function are created and checked, with their functionalities, separately for each individual system component and are successively installed in each system component on the basis of a prescribed plan and are configured and checked separately for each system component, taking account of the dependencies among the individual system components. The dependencies among the individual system components cannot be automatically installed, configured and verified.

Installing the software packages on the various system components and configuring the relationships and dependencies between the system components require extensive expert knowledge, since the procedure for installing and configuring the software packages is often described only inadequately in the guidelines and instructions prescribed therefor and is difficult to comprehend.

The plans for the system structure and the identification of the system components for complete and correct installation of the relationships and dependencies among the system components are also created manually and checked separately for each system component, which means that the administrative involvement for creating, verifying, installing and configuring the software packages has an associated high level of time involvement and increases even more the more extensive the form of the installation topology.

The invention is accordingly based on the object of specifying a system for automatically installing, verifying and configuring functionalities, stored in files, particularly in installation, verification and/or configuration files, for system components arranged in a distributed network, particularly in a distributed automation system, which avoids the aforementioned drawbacks.

The invention achieves this object by means of a system having the features specified in claim 1. An appropriate method for implementation in the inventive system is specified in claim 6.

In line with the invention, the system for automatically creating, installing and configuring functionalities, stored in installation, verification and/or configuration files, for system components arranged in a distributed network comprises a knowledge-based system planning tool having a user interface, a planning logic unit, a data management unit, a planning database and an installation tool.

The user interface transmits user-selected system options, which include the system structure, also called system topology, the system types used with the appropriate functionalities, such as the operating system to be selected or the manner of system functionality, for example, to the planning logic unit and to the data management-unit.

The planning logic unit uses a data and rule manager integrated in the data management unit to produce installation, verification and/or configuration plans for further processing in the data management unit from the system options.

The planning database records system information, such as system installation information, system dependencies, system configuration steps and system limit information for selecting the automation system, the operator stations and engineering stations, the controller communication, the archiving system, the integration of the application servers and the field transmitters, which is supplied to the data management unit.

The data management unit uses an integrated data generator to generate and configure a system structure, comprising installation, verification and/or configuration information, subsequently also called software packages, from the system options in the user interface and from the system information on a data and rule basis, and ascertains all the necessary installation steps for transmitting the functionalities stored in the data packages to the system components.

The system which the data generator develops from the system options, system information, system structure plans and the dependencies from the data and rule manager stipulates, during generation, which files are part of a package and examines them for dependencies and conflicts, so that they can be installed in the system components fully and in the correct order and can also be overwritten by new versions. Software packages which are dependent on one another can thus be installed only together, distributed over the various system components, which eliminates conflicts and time-consuming configuration operations within the individual system components.

The packages created, with the system data and setup data for each system component, such as system component type and name, operating system, environment used for the operating system, hardware requirements, network settings, dependencies among the system components and selected system capabilities and also stipulated configuration data for the respective system component, are transferred to the installation tool.

Once the software packages for the system components have been generated, the installation tool checks the system requirements, adds missing data if required and transmits the software packages to the respective system components.

Following successful automatic installation of the software packages in the system components, the method for providing the distributed system for the system components of the distributed system is at an end and the system components are configured automatically.

In one alternative variant embodiment, the software packages can also be configured under user guidance.

In one advantageous development, the knowledge-based system planning tool is extended by a change unit for maintaining the planning data stored in the planning database and/or the plans produced by the planning logic unit, and for this purpose the change unit is equipped with an integrated export/import functionality, for example for interchanging the planning data, and integration of additional user-defined options for matching the data and plans.

When the system information has been updated using the change unit, the data generator is advantageously able to fetch the newly created information for updated packages from the data management unit and ascertain updated installation, verification and/or configuration files.

The inventive method describes a number of steps which are used for automatically creating and checking software packages generated in the knowledge-based system planning tool for each individual system component and for installing and configuring them in the system components of the distributed system in order to transfer the distributed system to an operational state.

In this case, system options selected using a user interface are provided for a planning logic unit and a data management unit, and a planning database is used to store system information for the data management unit.

The planning logic unit is used to produce plans for the system structure from the system options in the user interface and from planning data from the data management unit and to supply them to the data management unit, and also the data management unit is used to generate and configure software packages from the system options in the user interface, from the system information in the planning database and from the plans for the system structure which are produced in the planning logic unit, and to transfer them to the installation tool.

In one advantageous variant embodiment, a change unit is used to update the planning data stored in the planning database and/or the plans produced by the planning logic unit, and a data generator is used to generate up-to-date system components.

The advantages of the invention can also be seen in that the automatic creation, verification, installation and configuration of the software packages for the individual system components involves rules, stipulations and dependencies among the system components being taken into account and checked.

The installation and configuration require no expert knowledge, since the manner and the order of installation and configuration are stipulated by the data generator in the data management unit.

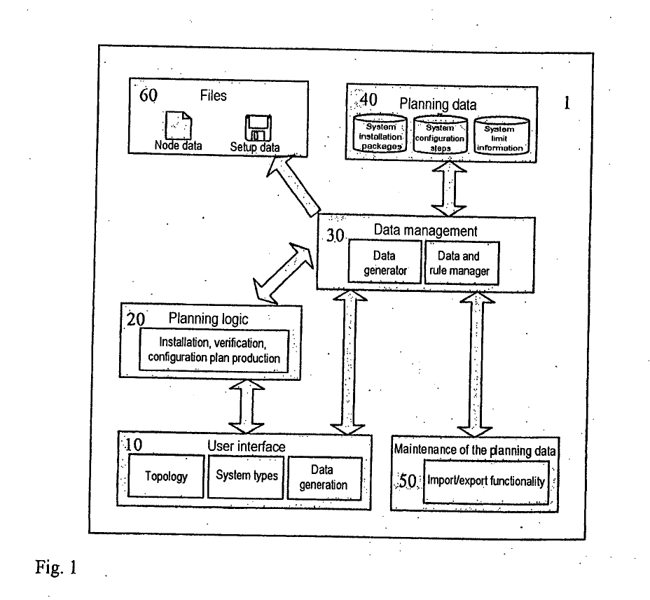

Exemplary embodiments illustrated in FIGS. 1-5 will be used to explain and describe the invention and also advantageous refinements and improvements of the invention in more detail.

In the figures:

FIG. 1 shows an exemplary knowledge-based system planning tool for automatically creating, installing, checking and configuring installation, verification and/or configuration files for system components arranged in a distributed network,

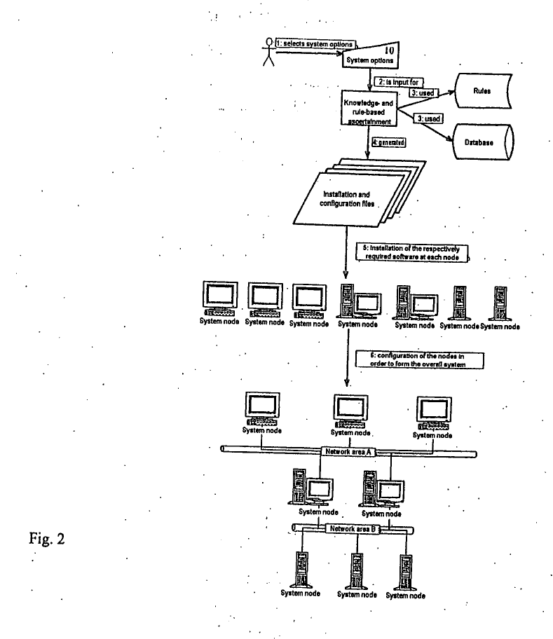

FIG. 2 shows an exemplary method sequence for the automatic creation, installation and configuration of installation, verification and/or configuration files for system components arranged in a distributed network,

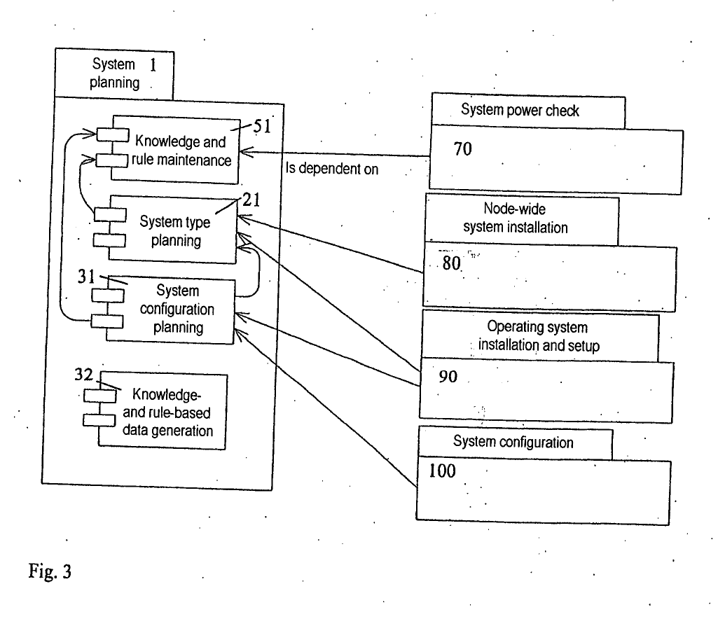

FIG. 3 shows exemplary dependencies between the various method steps for the system planning in the system planning tool for implementing the inventive system, and

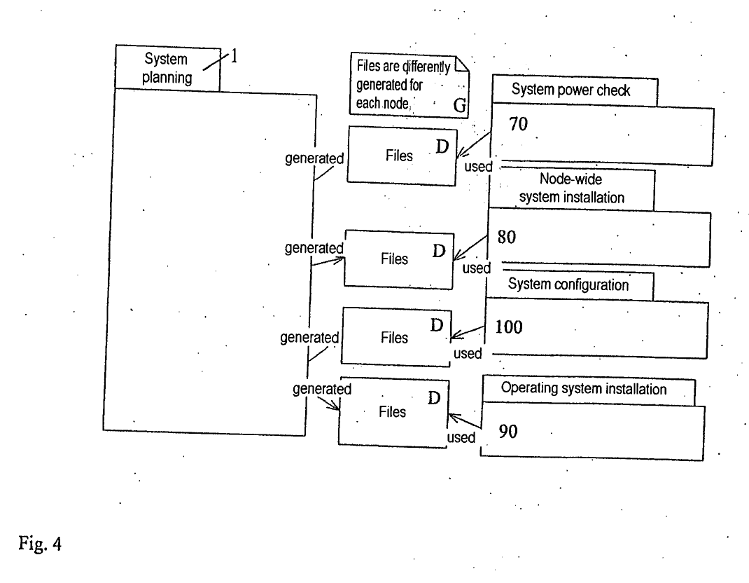

FIG. 4 shows an exemplary overview of the generation of the installation, verification and/or configuration files for each system component.

FIG. 1 shows an exemplary knowledge-based system planning tool (1) for automatically creating, installing, checking and configuring installation, verification and/or configuration files, subsequently also called software packages, for system components arranged in a distributed network, where the knowledge-based system planning tool 1 comprises a user interface 10, a planning logic unit 20, a data management unit 30, a planning database 40 and an installation tool 60.

The user interface 10, which interacts with the planning logic unit 20 and the data management unit 30, stores selected system options, which include, by way of example, the system structure, the system types and operating systems used and also a selection option for the manner of data storage in the installation tool 60, for further processing in the planning logic unit 20 and the data management unit 30.

From the system options in the user interface 10, the planning logic unit 20 produces installation, verification and/or configuration plans for creating the system structure and transmits the plans to the data management unit 30 for further processing in the data management unit.

Using system information stored in the planning database 40 (said system information being system installation information, system configuration steps and system limit information, for example), using the system options in the user interface and using the plans for the system structure which are produced by the planning logic unit 20, the data management unit 30 generates and configures software packages by using a data and rule manager, managed by the data management unit 30, using an integrated data generator.

The data and rule manager examines the software packages created and hardware requirements for dependencies and conflicts among one another.

The software packages now comprise the functionalities which are to be installed in respective system components, such as system component data and setup data for the system components.

The created packages with the system data and setup data for each system component, such as system component type and name, operating system, environment used for the operating system, hardware requirements, network settings, dependencies among the system components and selected system capabilities and also stipulated configuration data for the respective system component, are transferred to the installation tool 60.

The data management unit 30 also interacts with a change unit 50 in order to update the planning data stored in the planning database 40 and/or the plans produced by the planning logic unit 20.

For this, the change unit 50 uses an integrated export/import functionality in order to change stipulations, dependencies and limitations for the respective system components, in particular, and also to interchange the planning data and to integrate additional user-defined options for adapting the data and plans.

When the system information has been updated using the change unit 50, the data generator is advantageously able to fetch the newly created packages from the data management unit and to reascertain updated installation, verification and/or configuration files. In this case, the newly created packages are again examined for dependencies and conflicts using the data and rule manager in the data manager unit 30 and are transferred to the installation tool 60.

FIG. 2 shows an exemplary method sequence for the automatic creation, installation and configuration of software packages for system components arranged in a distributed network.

The inventive method describes a number of steps which are used in the knowledge-based system planning tool 1 to create and check the software packages for each individual system component automatically on a data and rule basis and to install and configure them in the system components of the distributed system in order to transfer the distributed system to an operational state.

System options are selected in a first step 1 and are supplied to the system planning tool 1 for knowledge- and rule-based ascertainment in a second step 2.

In a third step 3, the data and rule manager managed by the data management unit 30 is used to create functionalities, using the data generator integrated in the data management unit 30, from the system options, the plans for the system structure which are created in the planning logic unit 20 and the system information provided by the planning database 40 and to check them automatically, taking account of rules, stipulations and dependencies among the system components.

In a fourth step 4, installation, verification and/or configuration files, also called software packages, are generated from the functionalities and the respectively required software packages are installed in the system components in a prescribed order and manner in a fifth step 5.

In a sixth step 6, the software packages in the system components are configured in a prescribed order in order to form an operational distributed system.

FIG. 3 shows exemplary dependencies between the various method steps of the system planning in the system planning tool 1 for implementing the inventive system using the system check 70, the system installation 80 in each system component, the operating system installation 90 and the configuration of the overall system 100.

The dependencies for the system check 70 relate particularly to the knowledge and rule maintenance which is provided in the change unit 50 and in the data management unit 30 and which, for its part, provides information for the system type planning 21 and for the system configuration planning 31.

For the system installation in the system components 80, the stipulations and dependencies from the system type planning 21 are processed and implemented, with the system type planning 21 transmitting information to the system configuration planning 31.

To implement the operating system installation and setup 90 in the system components, the system planning tool 1 provides the system plans 21 and system configuration plans 31, generated by means of the data management unit 30, using the relationships and dependencies between the system type planning 21 and the system configuration planning 31.

To configure the overall system, the system configuration plans 31 generated by the data management unit 30 are likewise provided and processed.

FIG. 4 shows an exemplary overview of the generation G of the installation, verification and/or configuration files in the system planning tool 1 for each system component and the use of the installation, verification and/or configuration files D for the system check 70, for the system installation 80 in each system component, for the operating system installation 90 and for the configuration 100 of the overall system.

1. A system for automatically installing, verifying and configuring functionalities, stored in installation, verification and/or configuration files, for system opponents arranged in a distributed network, where
a system planning tool for creating, checking and configuring the installation, verification and/or configuration files for the respective system components is provided,
the system planning tool transmits the installation, verification and/or configuration files for installation in the system components,
the respective system components automatically checks and configures the required installation, verification and/or configuration files in a prescribed order and manner, and
following the configuration of the system components an overall systems is formed.

2. The system as claimed in claim 1, wherein following the configuration of the system components among one another an operational overall system is formed.

3. The system as claimed in claim 1 wherein the functionalities stored in installation, verification and/or configuration files are software packages.

4. The system as claimed in claim 1, wherein the overall system is a distributed network, particularly a distributed automation system.

5. The system as claimed in claim 1, wherein the software packages store system component data and setup data for the system components.

6. A method for automatically installing and configuring functionalities, stored in installation, verification and/or configuration files, for system components arranged in a distributed network, where
a system planning tool is used to create, check and configure the installation, verification and/or configuration files for the respective system components,
the installation, verification and/or configuration files required in the respective system components are automatically installed, checked and configured in the respective system components in a prescribed order and manner, and
the system components are configured to form an overall system.

7. The method as claimed in claim 6, wherein following the configuration of the system components an operational overall system is formed.

8. The method as claimed in claim 6, wherein the functionalities stored in installation, verification and/or configuration files are in the form of software packages.

9. The method as claimed in claim 6, wherein the overall system is in the form of a distributed network, particularly in the form of a distributed automation system.

10. The method as claimed in claim 6, wherein the software packages are used to store system component data and setup data for the system components.

11. The system as claimed in claim 2, wherein the functionalities stored in installation, verification and/or configuration files are software packages.

12. The system as claimed in claim 11, wherein the overall system is distributed network, particularly a distributed automation system.

13. The system as claimed in claim 12, wherein the software packages store system component data and setup data for the system components.

14. The method as claimed in claim 7, wherein the functionalities stored in installation, verification and/or configuration files are in the form of software packages.

15. The method as claimed in claim 14, wherein the overall system is in the form of a distributed network, particularly in the form of a distributed automation system.

16. The method as claimed in claim 15, wherein the software packages are used to store system component data and setup data for the system components.
